(19) United States
(12) Patent Application Publication
(10) Pub. No.: US 2025/0306655 A1
(43) Pub. Date: Oct. 2, 2025

(54) Hardware-Based Hotspot Temperature and Offset Estimation Framework

(71) Applicant: Google LLC, Mountain View, CA (US)

(72) Inventors: Mohsen Heidarinejad, San Jose, CA (US); Arpit Mittal, San Jose, CA (US); Chunwei Yu, Saratoga, CA (US); Arjang Shahriari, Sunnyvale, CA (US)

(73) Assignee: Google LLC, Mountain View, CA (US)

(21) Appl. No.: 19/236,060

(22) Filed: Jun. 12, 2025

Related U.S. Application Data
(60) Provisional application No. 63/819,353, filed on Jun. 6, 2025.

(51) Int. Cl. G06F 1/20; G01K 7/42

(52) U.S. Cl. CPC G06F 1/206; G01K 7/42

(57) ABSTRACT

This document describes systems and techniques directed at a hardware-based hotspot temperature and offset estimation framework for systems on a chip (SoCs). In aspects, an SoC is configured to receive, by a correction module and from a prediction module, a predicted SoC hotspot temperature. The correction module compares the predicted SoC hotspot temperature with temperature sensor data from one or more process modules. Based on the comparison, the correction module generates an estimated SoC hotspot temperature. In aspects, an offset module receives a predicted SoC-hotspot temperature offset from the prediction module. The offset module compares the predicted SoC-hotspot temperature offset with the temperature sensor data and based on the comparison, generates an estimated SoC-hotspot temperature offset.

### CROSS-REFERENCE TO RELATED APPLICATION

This application claims the benefit of U.S. Provisional Patent Application Ser. No. 63/819,353 filed on Jun. 6, 2025, the disclosure of which is incorporated by reference herein in its entirety.

### SUMMARY

This document describes systems and techniques directed at a hardware-based hotspot temperature and offset estimation framework for systems on a chip (SoCs). In aspects, an SoC is configured to receive, by one or more modules, an estimated SoC hotspot temperature. The SoC is further configured to receive, by the one or more modules, an estimated SoC-hotspot temperature offset. Based on the estimated SoC hotspot temperature and the estimated SoC-hotspot temperature offset, the one or more modules generates a command, the command configured to change one or more operating conditions of one or more processors.

In some aspects, the techniques described herein relate to a method including receiving, by one or more modules, an estimated SoC hotspot temperature. The method further includes receiving, by the one or more modules, an estimated SoC-hotspot temperature offset. The method further includes generating, by the one or more modules, a command configured to change one or more operating conditions of the one or more processors based on the estimated SoC hotspot temperature and the estimated SoC-hotspot temperature offset.

In other aspects, the method may further include receiving, by a correction module, a predicted SoC hotspot temperature. The method may include comparing, by the correction module, the predicted SoC hotspot temperature with temperature sensor data from the one or more modules and generating, by the correction module and based on the comparison of the temperature sensor data to the predicted SoC hotspot temperature, the estimated SoC hotspot temperature. The method may additionally include receiving, by an offset module, a predicted SoC-hotspot temperature offset. The method may further include comparing, by the offset module, the predicted SoC-hotspot temperature offset with temperature sensor data from the one or more modules and generating, by the offset module and based on the comparison of the temperature sensor data to the predicted SoC-hotspot temperature offset, the estimated SoC-hotspot temperature offset.

This Summary is provided to introduce simplified concepts of a hardware-based hotspot temperature and offset estimation framework for SoCs, the concepts of which are further described below in the Detailed Description and Drawings. This Summary is not intended to identify essential features of the claimed subject matter, nor is it intended for use in determining the scope of the claimed subject matter.

### BRIEF DESCRIPTION OF THE DRAWINGS

The details of one or more aspects of systems and techniques directed at hardware-based hotspot temperature and offset estimation frameworks for SoCs are described in this document with reference to the following drawings, in which the use of same numbers in different instances may indicate similar features or components.

FIG. 1 illustrates an example environment in which aspects of a hardware-based hotspot temperature and offset estimation framework for SoCs can be implemented.

FIG. 2 illustrates example implementation of a computing device in which aspects of a hardware-based hotspot temperature and offset estimation framework for SoCs can be implemented.

FIG. 3 illustrates an example implementation in which aspects of a hardware-based hotspot temperature and offset estimation framework for SoCs can be implemented.

FIG. 4 illustrates example process modules in which aspects of a hardware-based hotspot temperature and offset estimation framework for SoCs can be implemented.

FIG. 5 illustrates another example implementation in which aspects of a hardware-based hotspot temperature and offset estimation framework for SoCs can be implemented.

FIG. 6 illustrates another example implementation in which aspects of a hardware-based hotspot temperature and offset estimation framework for SoCs can be implemented.

### DETAILED DESCRIPTION

### Overview

Electronic devices may include a system-on-chip (SoC) that applies a software-based temperature estimation and a fixed temperature offset estimation to the various elements of the SoC (e.g., one or more processors, one or more intellectual property (IP) agents). The software-based temperature estimation implementation may introduce challenges stemming from limited sensor coverage in SoCs and nonlinear thermal behavior of SoCs. For example, when a software-based temperature estimation is implemented, the few sensors placed on the SoC provide poor temperature estimations for other areas and/or elements of the SoC. The estimations may be extrapolated, which introduces errors, especially under high thermal gradients. Additionally, real-time performance constraints can present difficulties, as accurate temperature estimation requires complex models that can predict heat dissipation patterns based on rapidly changing workloads. Running such algorithms in software can potentially introduce computational overhead, processing-power overconsumption, and performance degradation of the electronic device. In another example, software-based temperature estimations must account for the highly variable and nonlinear thermal behavior across the different components of the SoC. The unpredictability of workloads, combined with the need for real-time adaptation, makes the development of accurate and efficient thermal models difficult. As a result, software-based temperature estimation frameworks may not carefully balance accuracy, computational cost, and power consumption to ensure effective thermal control without compromising user experience.

The fixed temperature offset estimation implementation may also lead to poor SoC thermal management decisions. For example, a fixed temperature offset cannot adapt to the dynamic nature of power consumption, workload variations, and the changing thermal distribution across an SoC. The fixed temperature offset may also assume a constant relationship between a temperature sensor reading and the SoC hotspot temperature, which can lead to inaccurate temperature estimates, either underestimating or overestimating the actual SoC hotspot temperature. Poor temperature estimates may lead to unnecessary throttling or cooling across the SoC which may impact the SoC performance, the SoC energy efficiency, and the SoC longevity. Overheating can accelerate SoC component degradation, reducing the lifespan of the SoC, while overly conservative thermal control management can waste energy and degrade SoC performance. To this end, this document describes systems and techniques directed to a hardware-based hotspot temperature and offset estimation framework for an SoC that ensures accurate temperature estimations.

The following discussion describes operating environments, techniques that may be employed in the operating environments, and example methods. Although techniques using systems and apparatuses in which aspects of a hardware-based hotspot temperature and offset estimation framework for SoCs are described, it is to be understood that the subject of the appended claims is not necessarily limited to the specific features or methods described. Rather, the specific features and methods are disclosed as example implementations and reference is made to the operating environment by way of example only.

### Operating Environment

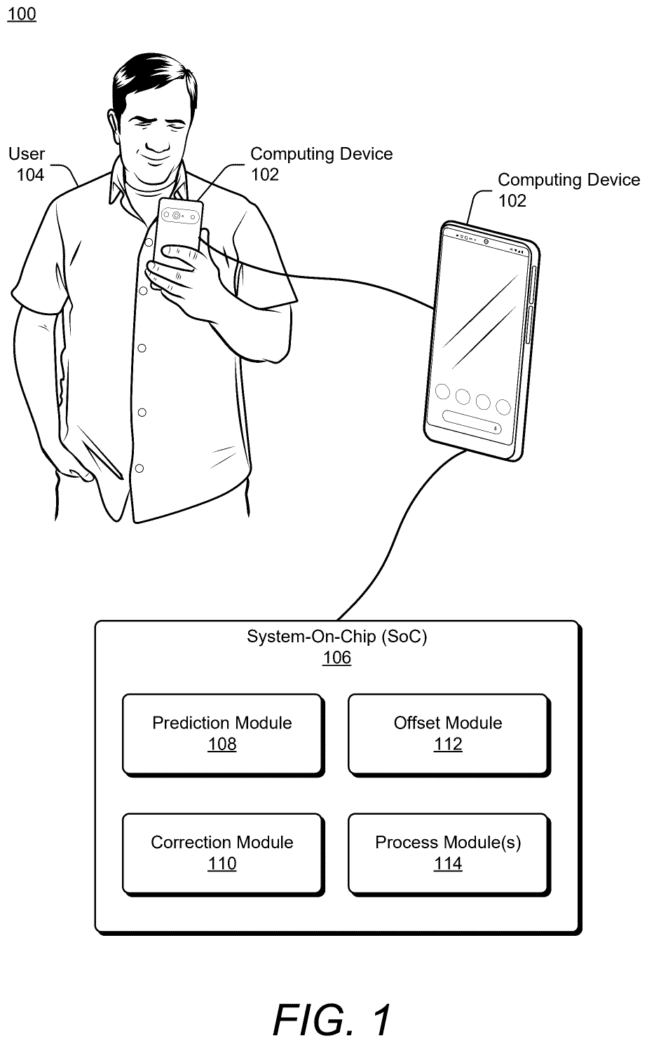

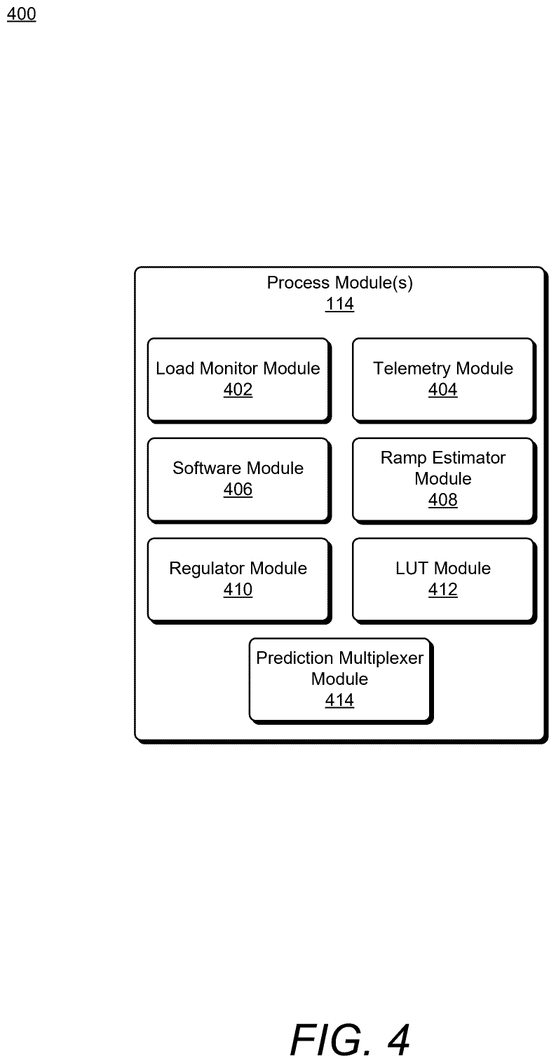

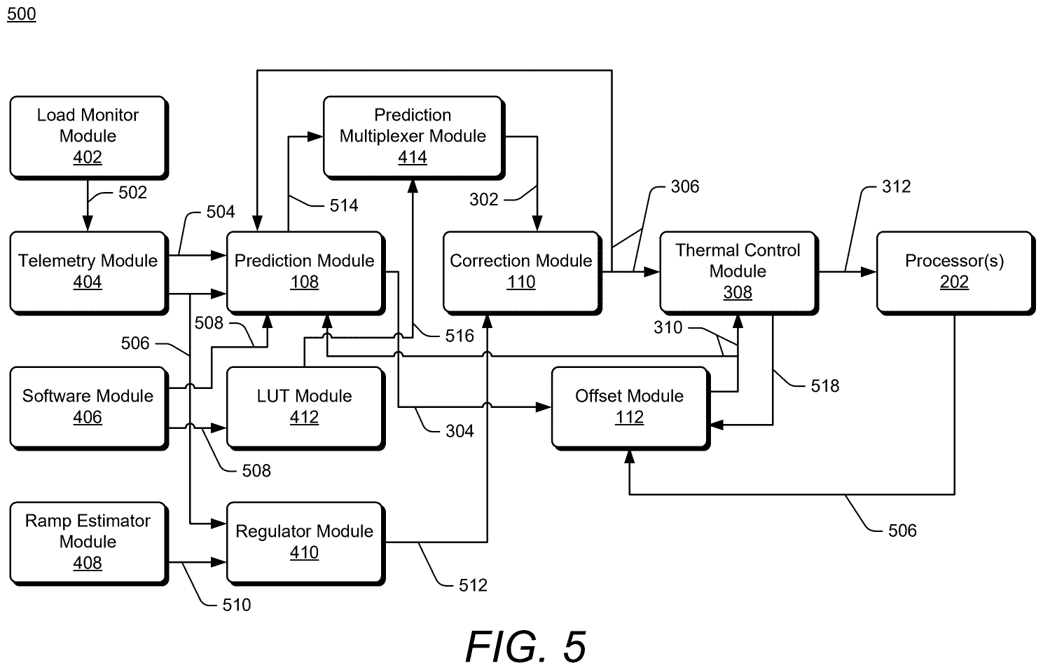

FIG. 1 illustrates an example environment 100 that implements aspects of a hardware-based hotspot temperature and offset estimation framework for SoCs. The example environment 100 includes a computing device 102, a user 104, and an SoC 106. The SoC 106 may include a prediction module 108, a correction module 110, an offset module 112, and one or more process modules 114. Types of the one or more process modules 114 are further described with respect to FIG. 4. Further details of interactions, which include the one or more process modules 114, are described with respect to FIG. 5.

The prediction module 108 may store model parameters, power consumption data, and temperature sensor data and may, based on the parameters and SoC data, predict an SoC hotspot temperature (e.g., a predicted SoC hotspot temperature). The correction module 110 may estimate an SoC hotspot temperature (e.g., an estimated SoC hotspot temperature) based on real-time power and temperature measurements and the predicted SoC hotspot temperature. Further, the prediction module 108 may predict an SoC-hotspot temperature offset (e.g., a predicted SoC-hotspot temperature offset) based on the model parameters and power consumption data. The offset module 112 may estimate an SoC-hotspot temperature offset (e.g., an estimated SoC-hotspot temperature offset) based on real-time power measurements and the predicted SoC-hotspot temperature offset.

In some examples, the correction module 110 may estimate the estimated SoC hotspot temperature based on the previous estimated SoC hotspot temperature. In other examples, the offset module 112 may estimate the estimated SoC-hotspot temperature offset based on the previous estimated SoC-hotspot temperature offset.

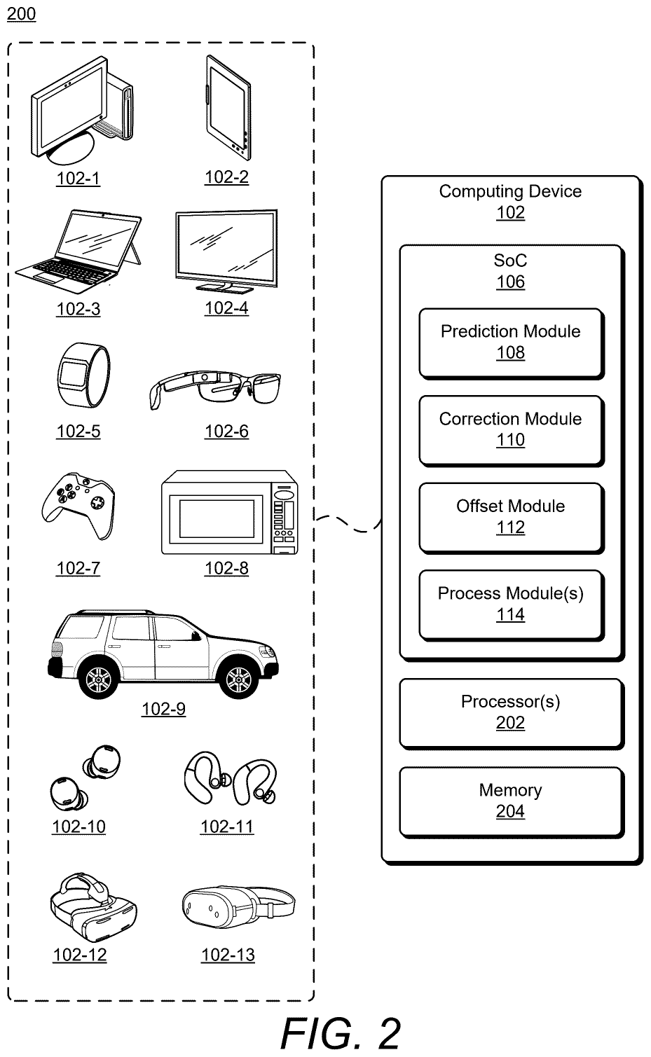

FIG. 2 illustrates an example implementation 200 of the computing device 102 of FIG. 1. The computing device 102 is illustrated with various non-limiting example devices, including a desktop computer 102-1, a tablet 102-2, a laptop 102-3, a television 102-4, a computing watch 102-5, computing glasses 102-6, a gaming system 102-7, a computing appliance 102-8, a vehicle 102-9, earbuds 102-10 (e.g., true-wireless earbuds, wired earbuds), hearing aids 102-11, a virtual-reality (VR) headset 102-12, and an augmented-reality (AR) headset 102-13. Other devices may also be used, including a home service device, a smart speaker, a smart thermostat, a baby monitor, a Wi-Fi™ router, a drone, a trackpad, a drawing pad, a netbook, an e-reader, a home automation and control system, a wall display, or another computing device. Note that the computing device 102 can be wearable, non-wearable but mobile, or relatively immobile (e.g., desktops and appliances). The computing device 102 includes the SoC 106, the prediction module 108, the correction module 110, the offset module 112, and the one or more process modules 114 as described in FIG. 1.

The computing device 102 also includes one or more processors 202 and at least one memory 204. The one or more processors 202 can include one or more of a central processing unit (CPU), a graphics processing unit (GPU), a tensor processing unit (TPU), a neural processing unit (NPU), an associative processing unit (APU), a field-programmable gate array (FPGA), or a visual processing unit (VPU). The memory 204 can include memory media and/or non-transitory storage media. An operating system (not shown) embodied as computer-readable instructions on the memory 204 can be executed by at least one of the one or more processors 202 and/or the SoC 106. In some examples, the prediction module 108, the correction module 110, the offset module 112, at least one of the one or more process modules 114, or a combination of these reside on the memory 204.

### Temperature and Offset Estimation Framework

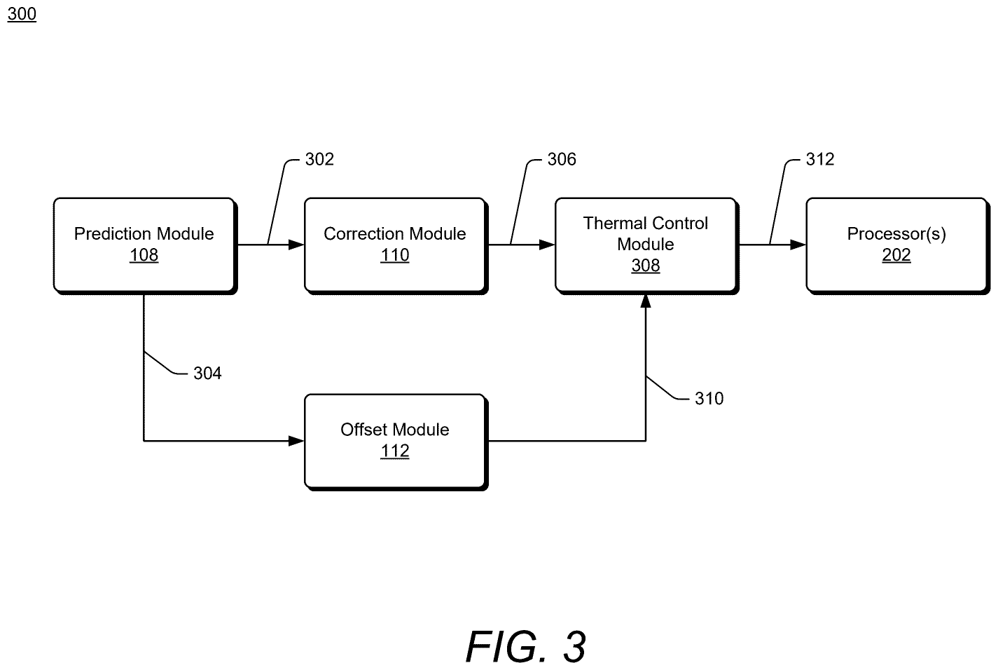

FIG. 3 illustrates an example implementation 300 in which aspects of a hardware-based hotspot temperature and offset estimation framework for SoCs can be implemented. The prediction module 108 (described with respect to FIG. 1) may predict an SoC hotspot temperature based on model parameters, power consumption data, and temperature sensor data. The prediction module 108 may output a predicted hotspot temperature 302 to the correction module 110 of FIG. 1. Additionally, the prediction module 108 may predict an SoC-hotspot temperature offset based on model parameters and power consumption data. The prediction module 108 may output a predicted hotspot-temperature offset 304 to the offset module 112 of FIG. 1.

The correction module 110 may compare the predicted hotspot temperature 302 with temperature sensor data from the one or more process modules 114 of FIG. 1 (not illustrated). Based on the comparison of the temperature sensor data to the predicted hotspot temperature 302, the correction module 110 can output an estimated hotspot temperature 306 to a thermal control module 308. The thermal control module 308 may include a thermal control algorithm and may provide feedback to the SoC 106 of FIG. 1 to ensure the accuracy of the estimated hotspot temperature 306.

The offset module 112 may compare the predicted hotspot-temperature offset 304 with the temperature sensor data. Based on the comparison of the temperature sensor data to the predicted hotspot-temperature offset 304, the offset module can output an estimated hotspot-temperature offset 310 to the thermal control module 308. The thermal control module 308 may use the estimated hotspot-temperature offset 310 and current temperature sensor measurements to output feedback back to the offset module 112.

The thermal control module 308 may output a command 312 to the one or more processors 202 of FIG. 2 based on the estimated hotspot temperature 306 and the estimated hotspot-temperature offset 310. The command 312 may be configured to change one or more operating conditions of the one or more processors 202. The one or more operating conditions may include one or more of a temperature, a power output, an operating voltage, or an operating frequency. For example, the thermal control module 308 determines that a GPU of a computing device (e.g., the computing device 102 of FIG. 1) is operating near a thermal limit based on a high estimated hotspot temperature 306 and, in response, generates a command 312 to reduce the operating frequency of the GPU from 2.8 GHz to 2.2 GHz. The thermal control module 308 may also reduce the operating voltage of the GPU from 1.1 V to 1.0 V to further mitigate the thermal issues. The thermal management from the thermal control module 308 may help maintain performance of the SoC while protecting the hardware from thermal degradation.

FIG. 4 illustrates an example implementation 400 of the one or more process modules 114 from FIG. 1. A load monitor module 402 can send guidelines on power distribution to a telemetry module 404. The power distribution guidelines from the load monitor module 402 may improve power measurements and may lead to more accurate power measurement collection from the telemetry module 404. The telemetry module 404 may collect real-time power consumption data from one or more processors (e.g., the one or more processors of FIG. 2) through reading performance counters and/or power-monitoring circuits within the SoC 106 of FIG. 1 on a computing device (e.g., the computing device 102 of FIG. 1). Additionally, the telemetry module 404 may collect available temperature sensor data from temperature sensors within the SoC 106.

A software module 406 may load model parameters into the prediction module 108 of FIG. 1. The model parameters can be fixed parameters or adapted parameters during real-time operation of the SoC 106. The prediction module 108 may use the model parameters to output a model prediction. Depending on the operation point of the SoC 106, the software module 406 may deploy different models for initialization of the temperature and offset estimation framework.

A ramp estimator module 408 may estimate temperature ramp rates of the SoC 106 and may send the temperature ramp rates to a regulator module 410. The regulator module 410 can monitor power consumption levels and the temperature ramp rates to calculate and recommend an efficiency criteria to the correction module 110 of FIG. 1. The efficiency criteria may be a function of power and/or area constraints along with the temperature ramp rates. The regulator module 410 may adjust the complexity of the efficiency criteria through replacing complex matric inversion operations with simplified matrix operations. Complex matrix inversion operations may be expensive to implement and/or continuously run in hardware, so adjusting the design complexity of the efficiency criteria may lead to more accurate power consumption and temperature estimations.

A look-up table (LUT) module 412 may be a pre-filled LUT that can be programmed to provide a quick prediction (e.g., a LUT prediction) based on model parameters from the software module 406. The LUT module 412 may address the tradeoff between speed, accuracy, and storage size based on the model parameters. The LUT module 412 may send the LUT prediction to a prediction multiplexer module 414. The prediction multiplexer module 414 may select one of the LUT prediction or the model prediction (e.g., from the prediction module 108), and, based on that selection, the prediction multiplexer module 414 may output the predicted hotspot temperature 302 of FIG. 3. In aspects, the software module 406 helps the prediction multiplexer module 414 to select the prediction best suited for the SoC 106 based on power consumption data and temperature data. The predicted hotspot temperature 302 may be the LUT prediction from the LUT module 412. Further, the predicted hotspot temperature 302 may be the model prediction from the prediction module 108.

FIG. 5 illustrates an example implementation 500 in which aspects of a hardware-based hotspot temperature and offset estimation framework for SoCs can be implemented. The load monitor module 402 of FIG. 4 outputs power distribution guidelines 502 to the telemetry module 404 of FIG. 4. The telemetry module 404 outputs power consumption data 504 and temperature sensor data 506 to the prediction module 108 of FIG. 1. In aspects, the telemetry module 404 outputs the temperature sensor data 506 to the regulator module 410 of FIG. 4. Additionally, the telemetry module 404 may output the temperature sensor data 506 to the correction module 110 of FIG. 1.

In some aspects, the software module 406 of FIG. 4 outputs model parameters 508 to the prediction module and to the LUT module 412 of FIG. 4. The ramp estimator module 408 of FIG. 4 may output a temperature ramp rate 510 to the regulator module 410. The regulator module 410 may compare the temperature sensor data 506 with the temperature ramp rate 510 and, based on the comparison, may output efficiency criteria 512 to the correction module 110.

After receiving power consumption data 504, temperature sensor data 506, and model parameters 508, the prediction module 108 may output a model prediction 514 to the prediction multiplexer module 414 of FIG. 4. Based on the model parameters 508, the LUT module 412 may output a LUT prediction 516 to the prediction multiplexer module 414. The software module 406 may enable the prediction multiplexer module 414 to select one of the two paths (e.g., the model path or the LUT path) to output as the predicted hotspot temperature 302 of FIG. 3. In examples, the predicted hotspot temperature 302 is the model prediction 514. In other examples, the predicted hotspot temperature 302 is the LUT prediction 516.

In some examples, the prediction multiplexer module 414 outputs the predicted hotspot temperature 302 to the correction module 110. The correction module 110 may compare the predicted hotspot temperature 302 to the temperature sensor data 506 and may, based on this comparison, output the estimated hotspot temperature 306. In some aspects, the correction module 110 also compares the efficiency criteria 512 to the predicted hotspot temperature 302 and the temperature sensor data 506. The estimated hotspot temperature 306 may be sent to the thermal control module 308 of FIG. 3. In some examples, the estimated hotspot temperature 306 is a previous estimated hotspot temperature. The previous estimated hotspot temperature may be output by the correction module 110 to the prediction module 108. The prediction module 108 may compare the previous estimated hotspot temperature with the power consumption data 504 to generate a new model prediction 514.

The prediction module 108 may output the predicted hotspot-temperature offset 304 of FIG. 3 to the offset module 112 of FIG. 1. Based on real-time noisy sensor readings (e.g., temperature sensor data 506), the offset module 112 can output the estimated hotspot-temperature offset 310 of FIG. 3 to the thermal control module 308. In some examples, the estimated hotspot-temperature offset 310 is a previous estimated hotspot-temperature offset. The previous estimated hotspot-temperature offset may be output by the offset module 112 to the prediction module 108. The prediction module 108 may compare the previous estimated hotspot-temperature offset with the power consumption data 504 to generate a new predicted hotspot-temperature offset 304.

The thermal control module 308 may be configured to receive the estimated hotspot temperature 306 and the estimated hotspot-temperature offset 310 as guidelines to find the true SoC hotspot temperature. The thermal control module 308 may output feedback 518 to the offset module 112 to begin a feedback loop, which may lead to accurate SoC hotspot temperature estimations. The thermal control module 308 may also output the command 312 of FIG. 3 to the one or more processors 202 of FIG. 2. In some examples, the command 312 is based on a thermal policy of a thermal control algorithm of the thermal control module 308. The command 312 may be configured to alter one or more operating conditions of the one or more processors 202. The one or more operating conditions may include one or more of a temperature, a power output, an operating voltage, or an operating frequency. The one or more processors 202 may output real-time noisy sensor readings (e.g., temperature sensor data 506) to the offset module 112 as feedback so the offset module 112 can output a more accurate estimated hotspot-temperature offset 310.

Multiple output possibilities indicated in FIG. 5 from a single module of the one or more process modules 114 can be output along any one or more of the possible output paths. In some examples, fewer than all of the one or more process modules 114 provide an output to the prediction module 108. In other examples, fewer than all of the one or more process modules 114 provide an output to the correction module 110. In some examples, at least one of the one or more process modules 114 provides multiple outputs to the prediction module 108. In other examples, at least one of the one or more process modules 114 provides multiple outputs to the correction module 110. Various alternate and/or combination pathways not pictured for clarity can be equally employed.

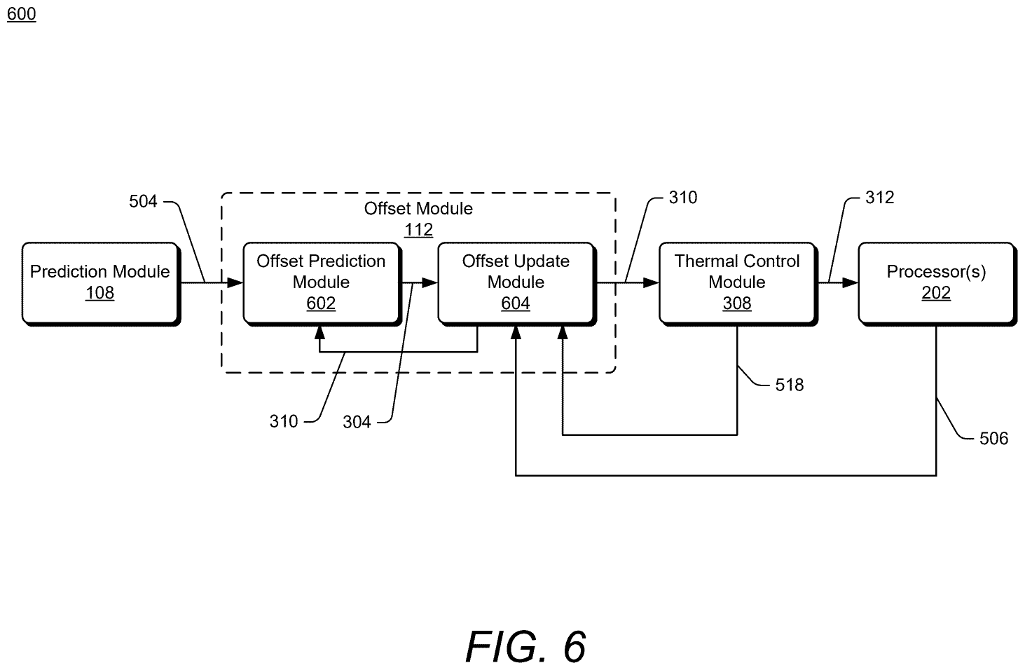

FIG. 6 illustrates an example implementation 600 in which aspects of a hardware-based hotspot temperature and offset estimation framework for SoCs can be implemented. The prediction module 108 of FIG. 1 may output the power consumption data 504 of FIG. 5 to an offset prediction module 602. The prediction module 108 may receive current and voltage data from one of the one or more process modules 114 of FIG. 1 (e.g., the load monitor module 402 and/or the telemetry module 404 of FIG. 4) to generate the power consumption data 504. Additionally, the prediction module 108 may generate the power consumption data 504 through reading performance counters and/or power-monitoring circuits within the SoC 106 of FIG. 1 on a computing device (e.g., the computing device 102 of FIG. 1). Based on the power consumption data 504, the offset prediction module 602 may output the predicted hotspot-temperature offset 304 of FIG. 3 to an offset update module 604. In aspects, the offset prediction module 602 and the offset update module 604 are part of the offset module 112 of FIG. 1.

The offset update module 604 may output the estimated hotspot-temperature offset 310 of FIG. 3 to the thermal control module 308 of FIG. 3 based on the temperature sensor data 506 of FIG. 5. The one or more processors 202 of FIG. 2 may output the temperature sensor data 506 as real-time noisy sensor readings to the offset update module 604 as feedback so the offset update module 604 can output a more accurate estimated hotspot-temperature offset 310.

In some examples, the estimated hotspot-temperature offset 310 is a previous estimated hotspot-temperature offset. The previous estimated hotspot-temperature offset may be output by the offset update module 604 to the offset prediction module 602. The offset prediction module 602 may compare the previous estimated hotspot-temperature offset with the power consumption data 504 to generate a new predicted hotspot-temperature offset 304.

The thermal control module 308 may be configured to receive the estimated hotspot-temperature offset 310 as a guideline to find the true SoC hotspot temperature. The thermal control module 308 may output feedback 518 to the offset update module 604 to begin a feedback loop, which may lead to accurate SoC hotspot temperature estimations. The thermal control module 308 may also output the command 312 of FIG. 3 to the one or more processors 202. The command 312 may be based on a thermal policy of a thermal control algorithm of the thermal control module 308. Additionally, the command 312 may be configured to alter one or more operating conditions of the one or more processors 202. The one or more operating conditions may include one or more of a temperature, a power output, an operating voltage, or an operating frequency. The one or more processors 202 may output real-time noisy sensor readings (e.g., temperature sensor data 506) to the offset update module 604 as feedback so the offset module 112 (e.g., the offset prediction module 602 and the offset update module 604) can output a more accurate estimated hotspot-temperature offset 310.

Multiple output possibilities indicated in FIG. 6 from the prediction module 108 can be output along any one or more of the possible output paths. In some examples, the prediction module 108 can output the predicted hotspot-temperature offset 304 to the offset update module 604. In other examples, the prediction module 108 can receive the estimated hotspot-temperature offset 310. Various alternate and/or combination pathways not pictured for clarity can be equally employed.

### CONCLUSION

Unless context dictates otherwise, use herein of the word “or” may be considered use of an “inclusive or,” or a term that permits inclusion or application of one or more items that are linked by the word “or” (e.g., a phrase “A or B” may be interpreted as permitting just “A,” as permitting just “B,” or as permitting both “A” and “B”). Also, as used herein, a phrase referring to “at least one of” a list of items refers to any combination of those items, including single members. For instance, “at least one of a, b, or c” can cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c, or any other ordering of a, b, and c). Further, items represented in the accompanying figures and terms discussed herein may be indicative of one or more items or terms, and thus reference may be made interchangeably to single or plural forms of the items and terms in this written description.

Although implementations for a hardware-based hotspot temperature and offset estimation framework for SoCs have been described in language specific to certain features and/or methods, the subject of the appended claims is not necessarily limited to the specific features or methods described. Rather, the specific features and methods are disclosed as example implementations for a hardware-based hotspot temperature and offset estimation framework for SoCs.

What is claimed is:

1. A system-on-chip (SoC) comprising:
one or more processors;
one or more modules; and
a memory storing instructions that, when executed by the one or more processors, cause the one or more processors to:
receive, by the one or more modules, an estimated SoC hotspot temperature;
receive, by the one or more modules, an estimated SoC-hotspot temperature offset; and
generate, by the one or more modules, a command, the command configured to change one or more operating conditions of the one or more processors based on the estimated SoC hotspot temperature and the estimated SoC-hotspot temperature offset.

2. The SoC of claim 1, wherein:
the one or more modules comprise a correction module; and
the instructions are further configured to cause the one or more processors to:
receive, by the correction module, a predicted SoC hotspot temperature;
compare, by the correction module, the predicted SoC hotspot temperature with temperature sensor data from the one or more modules; and
generate, by the correction module and based on the comparison of the temperature sensor data to the predicted SoC hotspot temperature, the estimated SoC hotspot temperature.

3. The SoC of claim 2, wherein:
the one or more modules comprises a prediction module; and
the instructions are further configured to cause the one or more processors to:
receive, by the prediction module, a previous estimated SoC hotspot temperature;
compare, by the prediction module, the previous estimated SoC hotspot temperature with power consumption data from the one or more modules;
generate, by the prediction module and based on the comparison of the power consumption data to the previous estimated SoC hotspot temperature, the predicted SoC hotspot temperature; and
output, by the prediction module, the predicted SoC hotspot temperature to the correction module.

4. The SoC of claim 1, wherein:
the one or more modules comprise an offset module; and
the instructions are further configured to cause the one or more processors to:
receive, by the offset module, a predicted SoC-hotspot temperature offset;
compare, by the offset module, the predicted SoC-hotspot temperature offset with temperature sensor data from the one or more modules; and
generate, by the offset module and based on the comparison of the temperature sensor data to the predicted SoC-hotspot temperature offset, the estimated SoC-hotspot temperature offset.

5. The SoC of claim 4, wherein:
the one or more modules comprises a prediction module; and
the instructions are further configured to cause the one or more processors to:
receive, by the prediction module, a previous estimated SoC-hotspot temperature offset;
compare, by the prediction module, the previous estimated SoC-hotspot temperature offset with power consumption data from the one or more modules;
generate, by the prediction module and based on the comparison of the power consumption data to the previous estimated SoC-hotspot temperature offset, the predicted SoC-hotspot temperature offset; and
output, by the prediction module, the predicted SoC-hotspot temperature offset to the offset module.

6. The SoC of claim 1, wherein the one or more operating conditions of the one or more processors comprise a temperature, a power output, an operating voltage, or an operating frequency.

7. The SoC of claim 1, further comprising one or more of:
one or more temperature sensors;
one or more performance counters; or
one or more power-monitoring circuits.

8. The SoC of claim 7, wherein the one or more modules receives the temperature sensor data from the one or more temperature sensors and receives power consumption data from one of the one or more performance counters or the one or more power-monitoring circuits.
